(19) United States
(12) Patent Application Publication
(10) Pub. No.: US 2019/0048859 A1
(43) Pub. Date: Feb. 14, 2019

(54) SOLAR ENERGY POWER GENERATION SYSTEM

(71) Applicant: Do Sun IM, Norfolk, VA (US)

(72) Inventor: Do Sun IM, Norfolk, VA (US)

(21) Appl. No.: 15/675,039

(22) Filed: Aug. 11, 2017

(51) Int. Cl. F03G 6/06; F01K 13/00; F22B 1/00

(52) U.S. Cl. CPC F03G 6/067; F01K 7/16; F22B 1/006; F01K 13/006

(57) ABSTRACT

Disclosed is a solar energy power generation system capable of effectively collecting solar energy resulting in high electricity generation efficiency. The solar energy power generation system includes a solar energy collector configured to collect solar heat and to convert an energy absorption medium into a gaseous state, a steam turbine configured to generate kinetic energy using the energy absorption medium in the gaseous state generated in the solar energy collector, a generator configured to convert the kinetic energy generated in the steam turbine into electric energy, a condenser configured to cool the energy absorption medium in the gaseous state discharged from the steam turbine into a liquid state, and a circulation pump configured to pump the energy absorption medium in the liquid state cooled by the condenser toward the solar energy collector. The solar energy collector includes a solar energy collection pipe having an absorption medium flow path for allowing the energy absorption medium to flow therethrough, and at least one lens configured to concentrate solar energy on the solar energy collection pipe.

### TECHNICAL FIELD

The present invention relates to a solar energy power generation system.

### BACKGROUND

Solar energy is the most abundant energy resource on the earth and may be defined as radiant energy (heat or light) emitted from the sun to the earth. Recently it has been drawing attention in production of electric energy using such solar energy.

There are two well known methods of harvesting solar energy into the energy we need. One is photovoltaic and the other is Concentrated Solar Power (CSP).

However, the photovoltaic system has low power generation efficiency and therefore has a disadvantage that light collecting plates should be installed in a wide region in order to cover the required power amount. Furthermore, the photovoltaic system cannot generate electricity when the solar light is weak due to cloudy weather. Therefore, the photovoltaic system has a drawback that a very-expensive large-capacity battery for storing energy needs to be used in order to supply electricity when the solar light is weak. For this reason, there is a limit to using the photovoltaic system for commercial power generation.

On the other hand, the current CSP systems require a massive initial investment due to its large infrastructural needs, and the current efficiency of the system is not justifiable to its high levelized cost of electricity

As a result, the CSP system is required to improve the photovoltaic collection efficiency, to lower the energy production cost and the cost of installing facilities and equipment, and to stably generate the electricity.

### PRIOR ART DOCUMENT

(Patent Document 1): Korean Patent Publication No. 10-1052120 (published on Jul. 20, 2011)

### SUMMARY

Embodiments of the present invention provide a solar energy power generation system capable of effectively collecting solar energy resulting in high electricity generation efficiency.

In accordance with a first aspect of the present invention, there is provided a solar energy power generation system, including: a solar energy collector configured to collect solar energy and to convert an energy absorption medium into a gaseous state; a steam turbine configured to generate kinetic energy using the energy absorption medium in the gaseous state generated in the solar energy collector; a generator configured to convert the kinetic energy generated in the steam turbine into electric energy; a condenser configured to cool the energy absorption medium in the gaseous state discharged from the steam turbine into a liquid state; and a circulation pump configured to pump the energy absorption medium in the liquid state cooled by the condenser toward the solar energy collector, wherein the solar energy collector includes a solar energy collection pipe having an absorption medium flow path for allowing the energy absorption medium to flow therethrough, and at least one lens configured to concentrate solar energy on the solar energy collection pipe.

In accordance with a second aspect of the present invention, there is provided a solar energy power generation system, including: a solar energy collector configured to collect solar heat and to heat an energy absorption medium; a heat exchanger configured to convert a working fluid into a gaseous state using the energy absorption medium heated by the solar energy collector; a steam turbine configured to generate kinetic energy using the working fluid in the gaseous state generated in the heat exchanger; a generator configured to convert the kinetic energy generated in the steam turbine into electric energy; a condenser configured to cool the working fluid in the gaseous state discharged from the steam turbine into a liquid state; and a circulation pump configured to pump the working fluid in the liquid state cooled by the condenser toward the heat exchanger, wherein the solar energy collector includes a solar energy collection pipe having an absorption medium flow path for allowing the energy absorption medium to flow therethrough, and at least one lens configured to concentrate solar energy on the solar energy collection pipe.

The solar energy collection pipe may include a plurality of solar energy collection pipes arranged in a form of a row, a column or a matrix.

The solar energy collection pipe may include: a solar energy collection body portion including a focusing portion through which the solar energy concentrated by the lens is transmitted into the solar energy collection pipe; and an insulating portion configured to cover at least a part of a remaining portion, of the solar energy collection body portion, other than the focusing portion.

The solar energy collection pipe may include: a solar energy collection support portion configured to provide the absorption medium flow path; an insulating portion configured to cover the solar energy collection support portion; and a solar energy collection window portion connected to the solar energy collection support portion so that the solar energy passes through the solar energy collection window portion, wherein the solar energy collection window portion has an arc-shaped cross section whose radius of curvature is the same as a radius of curvature of the solar energy collection support portion.

The solar energy collection pipe may further include a solar energy reflector portion disposed on an inner surface of the solar energy collection support portion, and the solar energy reflector portion may have an arc-shaped cross section and is concentrically disposed with respect to the solar energy collection support portion.

The solar energy collector may further include: a collector pipe spaced apart by a predetermined distance from the solar energy collection pipe and configured to cover the solar energy collection pipe, wherein the collector pipe may include a collector body portion and a collector window portion including a focusing portion configured to transmit the solar energy concentrated by the lens into the collector pipe.

The solar energy collector may further include: a first collection line which connects the solar energy collection pipe to the heat exchanger and allows the energy absorption medium to flow therethrough; a second collection line which connects the heat exchanger to the solar energy collection pipe and allows the energy absorption medium to flow therethrough; and a collection pump configured to circulate the energy absorption medium between the solar energy collection pipe and the heat exchanger.

The lens may include a Fresnel lens disposed so that a focal line passes through an edge of the lens.

The lens may include a Fresnel lens disposed so that a focal line passes through between a center and an edge of the lens.

The lens may include two or more lenses.

The solar energy collector may include a plurality of pairs of the lens and the solar energy collection pipe.

According to the embodiments of the present invention, it is possible to effectively collect solar energy through a solar energy collection pipe. This makes it possible to stably receive heat required for solar energy power generation and to stably generate electricity.

### BRIEF DESCRIPTION OF THE DRAWINGS

FIG. 1 is a conceptual diagram showing a solar energy power generation system according to one embodiment of the present invention.

FIG. 2 is a conceptual diagram showing a state in which a plurality of lenses and a plurality of solar energy collection pipes are collectively arranged in the solar energy power generation system according to one embodiment of the present invention.

FIG. 3 is a sectional view showing a solar energy collector for the solar energy power generation system according to one embodiment of the present invention.

FIGS. 4A to 4C are views showing lenses of solar energy collectors for a solar energy power generation system according to a first modification of one embodiment of the present invention.

FIG. 5 is a view showing a lens of a solar energy collector for a solar energy power generation system according to a second modification of one embodiment of the present invention.

FIG. 6 is a sectional view showing a solar energy collector for a solar energy power generation system according to a third modification of one embodiment of the present invention.

FIG. 7 is a sectional view showing a solar energy collector for a solar energy power generation system according to a fourth modification of one embodiment of the present invention.

FIG. 8 is a sectional view showing a solar energy collector for a solar energy power generation system according to a fifth modification of one embodiment of the present invention.

FIG. 9 is a sectional view showing a solar energy collector for a solar energy power generation system according to a sixth modification of one embodiment of the present invention.

FIG. 10 is a sectional view showing a solar energy collector for a solar energy power generation system according to a seventh modification of one embodiment of the present invention.

FIG. 11 is a conceptual diagram showing a solar energy power generation system according to another embodiment of the present invention.

FIG. 12 is a conceptual diagram showing a state in which a plurality of lenses and a plurality of solar energy collection pipes are collectively arranged in the solar energy power generation system according to another embodiment of the present invention.

FIG. 13 is a conceptual diagram showing a solar energy power generation system according to a further embodiment of the present invention.

### DETAILED DESCRIPTION

Hereinafter, configurations and operations of embodiments will be described in detail with reference to the accompanying drawings. The following description is one of various patentable aspects of the invention and may form a part of the detailed description of the invention.

However, in describing the invention, detailed descriptions of known configurations or functions that make the invention obscure may be omitted.

The invention may be variously modified and may include various embodiments. Specific embodiments will be exemplarily illustrated in the drawings and described in the detailed description of the embodiments. However, it should be understood that they are not intended to limit the invention to specific embodiments but rather to cover all modifications, similarities, and alternatives which are included in the spirit and scope of the invention.

The terms used herein, including ordinal numbers such as “first” and “second” may be used to describe, and not to limit, various components. The terms simply distinguish the components from one another. When it is said that a component is “connected” “coupled” or “linked” to another component, it should be understood that the former component may be directly connected or linked to the latter component or a third component may be interposed between the two components. Specific terms used in the present application are used simply to describe specific embodiments without limiting the invention. An expression used in the singular encompasses the expression of the plural, unless it has a clearly different meaning in the context.

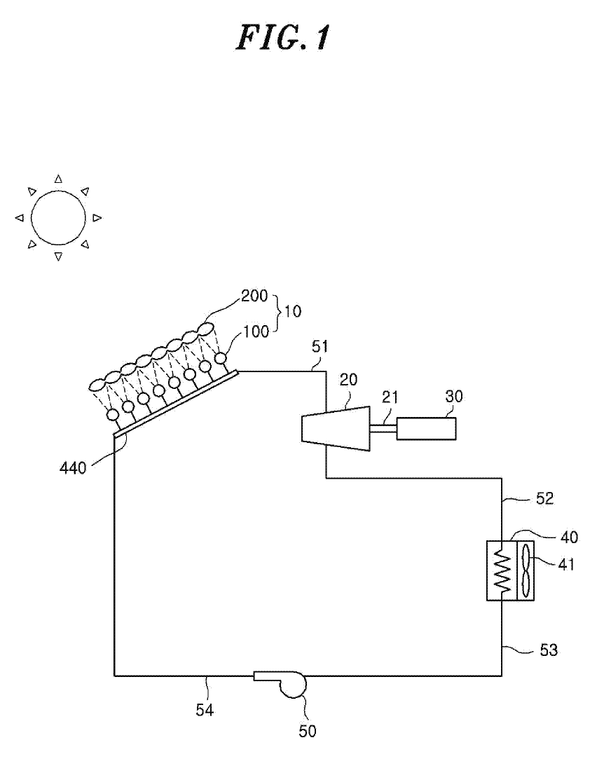

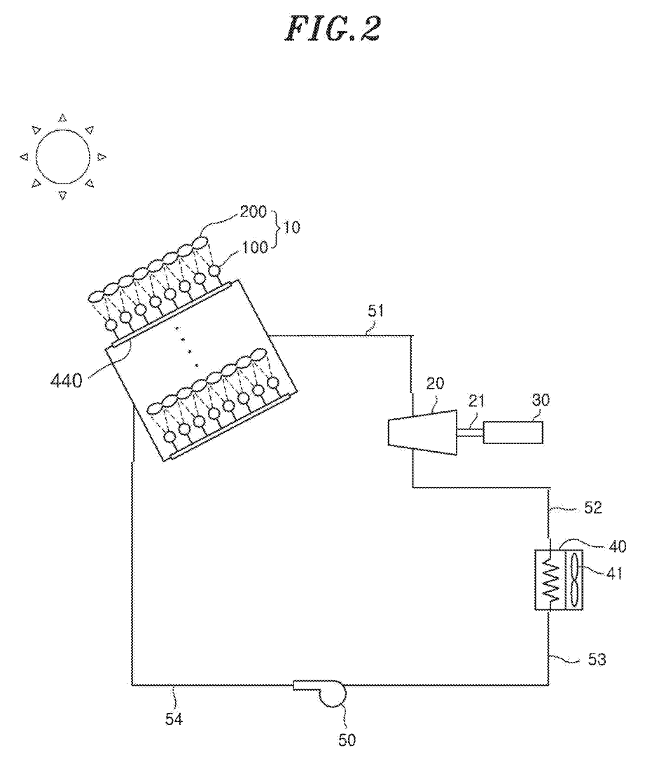

FIG. 1 is a conceptual diagram showing a solar energy power generation system according to one embodiment of the present invention. FIG. 2 is a conceptual diagram showing a state in which a plurality of lenses and a plurality of tubes are collectively arranged in the solar energy power generation system according to one embodiment of the present invention.

As shown in FIG. 1, the solar energy power generation system according to one embodiment of the present invention may include a solar energy collector 10 configured to collect solar energy through a solar energy collection pipe 100 to supply an energy absorption medium in a gaseous state, a steam turbine 20 configured to supply kinetic energy using the energy absorption medium in the gaseous state, a generator 30 configured to convert the kinetic energy of the steam turbine 20 into electric energy, a condenser 40 configured to cool the energy absorption medium in the gaseous state into a liquid state, and a circulation pump 50 configured to circulate the energy absorption medium.

The solar energy collector 10 may collect heat from solar energy to heat the energy absorption medium. By virtue of such heating, the energy absorption medium may be converted into a gaseous state (steam state) in the solar energy collector 10. In this regard, the energy absorption medium may include all kinds of fluids capable of absorbing solar energy (solar radiant heat) and undergoing a phase change (from a gas to a liquid or vice versa). As an example, the energy absorption medium may be a volatile fluid (methanol, acetone, mercury, etc.), water (including water vapor), oil, an ethylene glycol mixture, and the like.

The solar energy collector 10 may effectively absorb solar energy through a plurality of solar energy collection pipes 100 arranged in a row, column or matrix pattern. In this case, the solar energy collection pipes 100 may be connected in parallel. The respective solar energy collection pipes 100 may be connected to one main pipe 440. The detailed configuration of the solar energy collector 10 will be described later.

The steam turbine 20 may be configured to operate according to a Rankine cycle. The steam turbine 20 may receive a hot energy absorption medium from the solar energy collector 10 and may supply kinetic energy. The steam turbine 20 may receive the energy absorption medium from the solar energy collector 10 through a first power generation line 51 and may supply the energy absorption medium to the condenser 40 through a second power generation line 52.

In the present embodiment, the solar energy power generation system using the Rankine cycle is described. However, the present invention is not limited thereto. In addition to the Rankine cycle, various cooling cycles may be used in the present embodiment. For example, it may be possible to adopt a cooling cycle for a Stirling engine in which a mechanical work is performed while applying heat to a gaseous working fluid such as air or the like and repeatedly compressing and expanding the gaseous working fluid. The Stirling engine technique applicable to the present embodiment is well-known in the art and, therefore, will not be described in detail.

The steam turbine 20 may be operated by an expansion pressure (plus delta pressure) of the energy absorption medium. Since a rotating shaft (not shown) of the steam turbine 20 and a driving shaft 21 of the generator 30 are integrally formed or directly connected, the generator 30 may be operated by the steam turbine 20. When the driving shaft 21 of the generator 30 is rotated by the steam turbine 20, electric energy is generated in the generator 30. In the present embodiment, the generator 30 may be a typical high-speed generator and, therefore, will not be described in detail.

The steam turbine 20 may include a rotating shaft (not shown) directly connected to the driving shaft 21 of the generator 30, an impeller (not shown) installed on the rotating shaft, and a steam case (not shown) configured to surround the impeller. If the impeller is rotated by the expansion pressure of the energy absorption medium introduced into the steam case and the contraction of the energy absorption medium due to cooling, the rotating shaft may be rotated by the rotation of the impeller. The driving shaft 21 of the generator 30 may be rotated by the rotation of the rotating shaft.

In the present embodiment, the steam turbine 20 may utilize a kinematic force that stems from a steam pressure and pushes and rotates the impeller (turbine blades). Moreover, the steam turbine 20 may utilize a thermodynamic force attributable to a pressure difference in the steam turbine 20 generated when a hot gas (e.g., steam) is condensed while passing through the impeller (turbine blades).

The generator 30, which is a power generation device used in the Rankine cycle to generate electric energy, may generate electric energy using the rotation of the driving shaft 21 by the operation of the steam turbine 20.

For example, the generator 30 may include a rotor (not shown) provided on the driving shaft 21, a stator (not shown) installed so as to surround the rotor, and a generator case (not shown) on which the stator is installed. In this case, one of the rotor and the stator may be formed of a permanent magnet, and the other of the rotor and the stator may be provided with an electromagnet. The configurations of the rotor and the stator are identical with or similar to the configurations of the rotor and the stator used for a typical power generation device and, therefore, will not be described in detail.

The condenser 40 may cool the energy absorption medium in the gaseous state discharged from the steam turbine 20 into a liquid state. For example, the condenser 40 may condense the energy absorption medium into a liquid state through the heat exchange between the external heat source (air) and the energy absorption medium, thereby increasing the differential pressure (delta pressure).

In this case, the external heat source (air) may exchange heat with the energy absorption medium through a blower fan 41 of the condenser 40 or natural convection. In particular, by controlling the air flow velocity in the blower fan 41, it is possible to control the flow of the air which is an external heat source. Eventually, the total energy amount of the solar energy power generation system may be controlled through the control of the blower fan 41.

The condenser 40 may convert steam into liquid in order to enhance the efficiency of the Rankine cycle. Moreover, the condenser 40 may further increase the torque of the steam turbine 20 by increasing the pressure deviation of the steam turbine 20 provided in the Rankine cycle.

The condenser 40 may be connected to the steam turbine 20 through the second power generation line 52 and may be connected to the circulation pump 50 through a third power generation line 53. Thus, the condenser 40 may receive the energy absorption medium in the gaseous state from the steam turbine 20 through the second power generation line 52 and may supply the energy absorption medium in the liquid state to the circulation pump 50 through the third power generation line 53.

The circulation pump 50, which is a pump for circulating the energy absorption medium on the cycle of the solar energy power generation system, may increase the pressure of the energy absorption medium received from the condenser 40. At this time, the circulation pump 50 may adjust the pressure level of the energy absorption medium, thereby controlling the total energy amount of the solar energy power generation system.

In order to reduce the load of the circulation pump 50, a check valve (not shown) or an equivalent gate control valve (not shown) may be installed between the circulation pump 50 and the main pipe 440 of the solar energy collection pipe 100.

The circulation pump 50 may be connected to the condenser 40 through the third power generation line 53 and may be connected to the solar energy collector 10 through a fourth power generation line 54. In the present embodiment, the circulation pump 50 is positioned between the third power generation line 53 and the fourth power generation line 54. However, the present invention is not limited thereto. Needless to say, the position of the circulation pump 50 may be variously changed as long as the circulation pump 50 can smoothly circulate the energy absorption medium on the cycle of the solar energy power generation system.

As shown in FIG. 2, in the solar energy power generation system according to one embodiment, a plurality of solar energy collectors 10 including solar energy collection pipes 100 and lenses 200 for the collection of solar energy may be collectively arranged in a mutually connected state.

For example, the solar energy collectors 10 including the solar energy collection pipes 100 and the lenses 200 connected in row may be collectively disposed in parallel.

Hereinafter, the configuration of the solar energy collector according to one embodiment of the present invention will be described in detail.

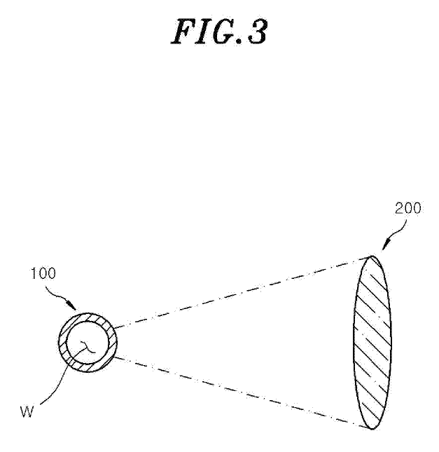

FIG. 3 is a sectional view showing the solar energy collector for the solar energy power generation system according to one embodiment of the present invention.

As shown in FIG. 3, the solar energy collector 10 may include a solar energy collection pipe 100 having a hollow tubular shape and a lens 200 for concentrating solar energy on the solar energy collection pipe 100.

The solar energy collection pipe 100 may have a tubular shape extending in one direction. An absorption medium flow path W through which an energy absorption medium can flow may be provided inside the solar energy collection pipe 100. The absorption medium flow path W may be formed to extend in the longitudinal direction (one direction) of the solar energy collection pipe 100. The energy absorption medium may flow along the longitudinal direction in the absorption medium flow path W. Furthermore, the energy absorption medium may be heated by the solar energy incident on the solar energy collection pipe 100 through the lens 200 while the energy absorption medium flows through the absorption medium flow path W. The energy absorption medium may be moved to the generator 30 through the absorption medium flow path W and may be used as a heat source for the generation of electricity.

The solar energy collection pipe 100 may be made of a material having high heat conductivity or a material capable of allowing solar energy to pass therethrough. As an example, the solar energy collection pipe 100 may be made of a material having high heat conductivity, such as aluminum, copper or an alloy thereof, or a material capable of effectively allowing solar energy to pass therethrough, such as glass, quartz, transparent plastic or the like.

The solar energy collection pipe 100 may be in the form of a tube having an annular cross section. Needless to say, the present invention is not limited thereto. The solar energy collection pipe 100 may have various cross-sectional shapes. For example, the solar energy collection pipe 100 may have an elliptical ring-shaped cross section or a polygonal ring-shaped cross section.

There may be provided a plurality of solar energy collection pipes 100. The solar energy collection pipes 100 may be arranged in the form of a row, a column or a matrix. The respective end portions of the solar energy collection pipes 100 may be connected to one another in a parallel relationship. As one example, the solar energy collector 10 may include 1,000 to 20,000 solar energy collection pipes 100. The 1,000 to 20,000 solar energy collection pipes 100 may be parallel-arranged in the form of a row, a column or a matrix, but the number of 1000 to 20000 is not limited to thereof, it can vary in accordance to the system requirement for the adequate function of particular power plant.

The solar energy collection pipes 100 may be connected to one main pipe 440. The main pipe 440 may be connected at one end to the first power generation line 51 and at the other end to the fourth power generation line 54. The energy absorption medium heated in the main pipe 440 is discharged to the first power generation line 51. After passing through the steam turbine 20, the generator 30 and the condenser 40, the energy absorption medium may be introduced into the main pipe 440 through the fourth power generation line 54.

The lens 200 may concentrate solar energy on the solar energy collection pipe 100. Furthermore, the lens 200 may have a bar shape extending along the longitudinal direction of the solar energy collection pipe 100.

The lens 200 may have a shape of a bar disposed parallel to a longitudinal axis line passing through the center of the solar energy collection pipe 100. The lens 200 may focus the solar energy incident on the lens 200 toward the internal center of the solar energy collection pipe 100. In other words, the lens 200 may have a convex shape when viewed in a cross section perpendicular to the longitudinal direction. That is to say, the central portion of the lens 200 in the transverse direction (the vertical direction in FIG. 3) may have a larger thickness than the transverse end portions.

Various kinds of lenses or reflectors for concentrating solar energy on the solar energy collection pipe 100 may be applied to the present embodiment as long as they can concentrate solar energy on the solar energy collection pipe 100. For example, a plurality of convex lenses may be disposed in a spaced-apart relationship along the longitudinal direction of the solar energy collection pipe 100. It may also be possible to adopt a bar type reflector having a concave vertical center.

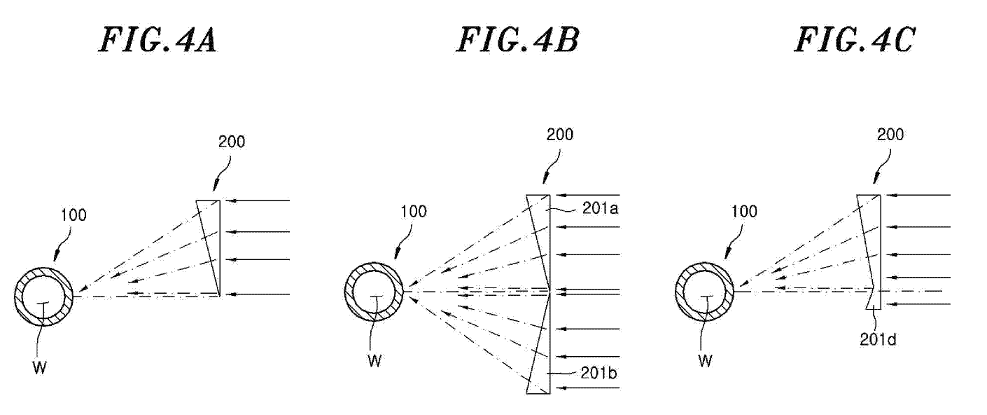

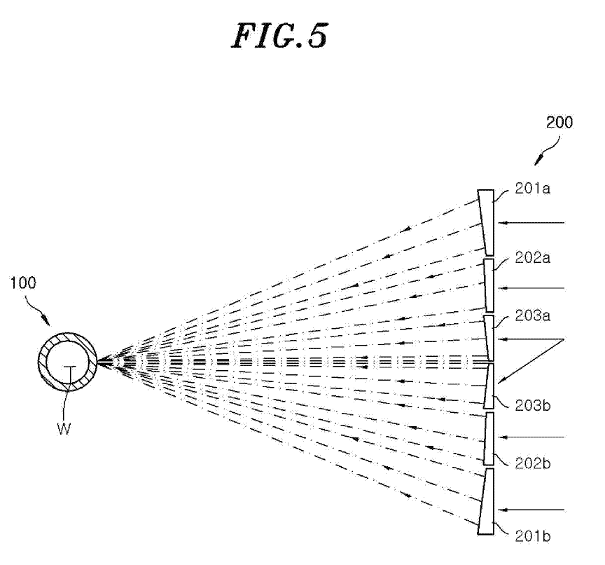

In the present embodiment, the lens 200 is a bar type lens. However, the present invention is not limited thereto. According to first and second modifications of one embodiment, the lens 200 may be a flat lens such as a Fresnel lens or the like. Hereinafter, the first and second modifications of one embodiment will be described with reference to FIGS. 4A to 4C and 5.

FIGS. 4A to 4C are views showing lenses of solar energy collectors for a solar energy power generation system according to a first modification of one embodiment of the present invention. FIG. 5 is a view showing a lens of a solar energy collector for a solar energy power generation system according to a second modification of one embodiment of the present invention.

As shown in FIG. 4A, the lens 200 may include one Fresnel lens whose focal line passes through an edge thereof. The term “focal line” may be defined as a path of light passing through a focal point of the lens 200 without being refracted. That is to say, the focal line refers to a path passing through the focal point of the lens 200 in a direction perpendicular to the lens 200. As shown in FIG. 4B, the lens 200 may include two Fresnel lenses 201a and 201b whose focal lines pass through the edges thereof. The two Fresnel lenses 201a and 201b may be disposed so as to have the same focal line. In addition, the two Fresnel lenses 201a and 201b may be disposed in a symmetrical relationship with each other.

As shown in FIG. 4C, the lens 200 may include a Fresnel lens 201d whose focal line passes through between the center and the edge thereof. However, the present invention is not limited thereto.

As shown in FIG. 5, the lens 200 may include two or more Fresnel lenses 201a, 202a, 203a, 201b, 202b, 203b and so forth, and may be disposed so as to have the same focal line. The focal line may pass through the Fresnel lenses 203a and 203b in FIG. 5 and may not pass through lenses 201a, 201b, 202a and 202b.

The lenses 200 are provided so as to correspond to the solar energy collection pipes 100. Therefore, when the solar energy collection pipes 100 are arranged in the form of a row, a column or a matrix, the lenses 200 may also be arranged in the form of a row, a column or a matrix. As one example, a plurality of bar type lenses may be provided as a plate having wavy concave-convex portions formed on the surface thereof.

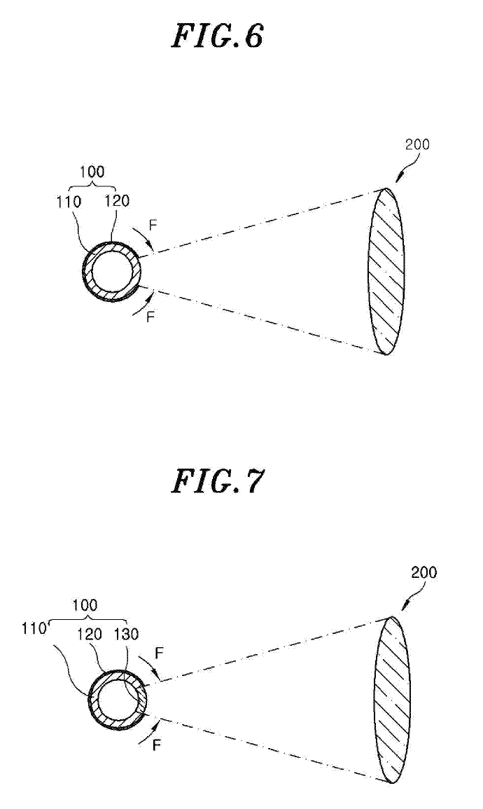

FIG. 6 is a sectional view showing a solar energy collector for a solar energy power generation system according to a third modification of one embodiment of the present invention.

As shown in FIG. 6, according to the third modification of one embodiment, the solar energy collection pipe 100 of the solar energy collector 10 may include a solar energy collection body portion 110 and an insulating portion 120. Hereinafter, the third modification will be described with an emphasis placed on the difference between the aforementioned embodiment and the third modification. The same portions as those of the aforementioned embodiment will be designated by the same reference numerals and will not be described again.

The solar energy collection body portion 110 may be divided into a focusing portion F that transfers solar energy to the inside thereof in order to concentrate the solar energy, and a remaining portion other than the focusing portion F. An insulating portion 120 for minimizing leakage of heat may be formed in the remaining portion other than the focusing portion F. The insulating portion 120 may not surround the entirety of the remaining portion but may partially surround the remaining portion.

For example, the solar energy collection pipe 100 may receive the solar energy incident on the lens 200 through the focusing portion F and the insulating portion 120 may prevent the solar energy in the solar energy collection pipe 100 from being leaked to the outside of the solar energy collection pipe 100. In other words, the insulating portion 120 is capable of minimizing a heat loss in the solar energy collection pipe 100.

The solar energy collection body portion 110 may be made of a material having high conductivity. For example, the solar energy collection pipe 100 may be made of aluminum, copper or an alloy thereof which is high in heat conductivity. The material of the solar energy collection body portion 110 may be selected in consideration of the strength at the expected highest temperature in the solar energy collection pipe 100, the insulating property, the corrosion resistance, the cost and the like. The cross section of the solar energy collection body portion 110 may be an arc shape or a circular shape having a predetermined radius of curvature.

The insulating portion 120 may surround or cover the remaining portion of the solar energy collection body portion 110 in order to insulate the remaining portion of the solar energy collection body portion 110 other than the focusing portion F. The insulating portion 120 may be selectively removed from the solar energy collection body portion 110 and may be disposed close to the solar energy collection body portion 110 when surrounding the solar energy collection body portion 110.

As one example, the solar energy collection body portion 110 may be an insulating material such as an urethane insulating material, a spring metal insulating material, a vinyl insulating material, a foamed rubber insulating material, polystyrene insulating material (foamed spongy), an insulating film or the like. In addition, various types of materials for insulating the solar energy collection pipe 100 may be used as the material of the insulating portion 120.

FIG. 7 is a sectional view showing a solar energy collector for a solar energy power generation system according to a fourth modification of one embodiment of the present invention.

As shown in FIG. 7, according to the fourth modification of one embodiment, the solar energy collection pipe 100 of the solar energy collector 10 may include a solar energy collection support portion 110′, an insulating portion 120 and a solar energy collection window portion 130.

The solar energy collection support portion 110′ may have a shape corresponding to a part of a cylinder. The solar energy collection support portion 110′ may have an arc-shaped cross section. The solar energy collection window portion 130 may have a shape corresponding to the other part of the cylinder. The solar energy collection window portion 130 may have an arc-shaped cross section. The combination of the solar energy collection support portion 110′ and the solar energy collection window portion 130 may have a shape (i.e., a cylindrical shape) corresponding to the solar energy collection body portion 110 described above. The solar energy collection window portion 130 may be connected to the solar energy collection support portion 110′ and the insulating portion 120. Hereinafter, the fourth modification will be described with an emphasis placed on the difference between the aforementioned embodiment and the fourth modification. The same portions as those of the aforementioned embodiment will be designated by the same reference numerals and will not be described again.

The solar energy collection window portion 130 may be disposed in a focusing portion F on which solar energy is intensively irradiated, and may be made of a material through which solar energy can be transmitted. The focusing portion F may include a portion of the solar energy collection pipe 100 through which the solar energy concentrated by the lens 200 passes to enter the solar energy collection pipe 100. For example, the solar energy collection window portion 130 may be a one-way window that permits transfer of radiant solar energy only in one direction in which solar energy is incident and prevents transfer of radiant solar energy in the other direction opposite to one direction. The cross section of the solar energy collection window portion 130 may have an arc shape having the same radius of curvature as the radius of curvature of the solar energy collection support portion 110′. However, the present invention is not limited thereto. The solar energy collection window portion 130 may be configured to have a flat shape.

In the present embodiment, the solar energy collection window portion 130 may be formed of a polarizing glass capable of transmitting solar energy. Alternatively, the solar energy collection window portion 130 may be formed of a polarizing film or a polarizing plastic that permits transfer of radiant solar energy only in one direction in which solar energy is incident.

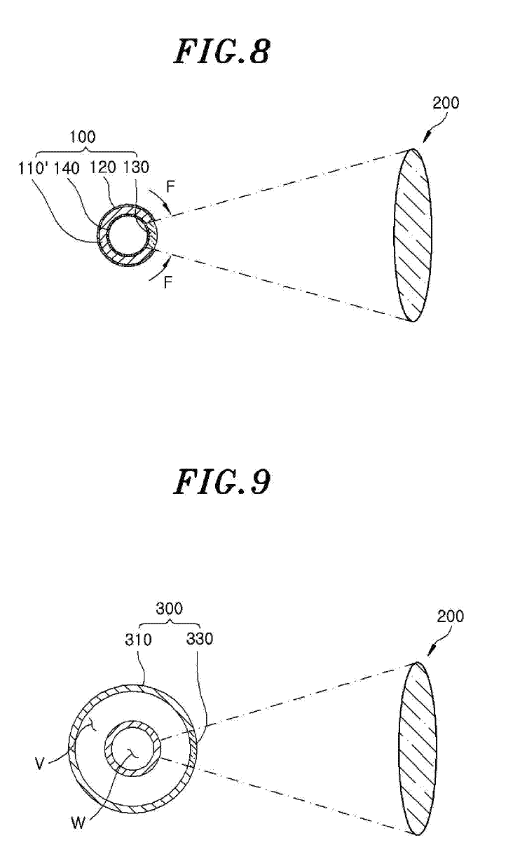

FIG. 8 is a sectional view showing a solar energy collector for a solar energy power generation system according to a fifth modification of one embodiment of the present invention.

As shown in FIG. 8, according to the fifth modification of one embodiment, the solar energy collection pipe 100 of the solar energy collector 10 may further include a solar energy reflector portion 140. Hereinafter, the fifth modification of one embodiment will be described with an emphasis placed on the difference between the aforementioned embodiment and the fifth modification. The same portions as those of the aforementioned embodiment will be designated by the same reference numerals and will not be described again.

The solar energy reflector portion 140 is capable of reflecting solar energy incident in the solar energy collection pipe 100. The solar energy reflector portion 140 may be provided on the inner surface of the solar energy collection support portion 110′. The solar energy reflector portion 140 may be a member such as a film or the like disposed on the inner surface of the solar energy collection support portion 110′ or may be a coating layer integrally formed with the inner surface of the solar energy collection support portion 110′ by vapor deposition. The cross section of the solar energy reflector portion 140 may be concentric with that of the solar energy collection support portion 110′ and may be configured to have an arc shape or a circular shape.

FIG. 9 is a sectional view showing a solar energy collector for a solar energy power generation system according to a sixth modification of one embodiment of the present invention.

As shown in FIG. 9, according to the sixth modification of one embodiment, the solar energy collector 10 may further include a collector pipe 300. Hereinafter, the sixth modification will be described with an emphasis placed on the difference between the aforementioned embodiment and the sixth modification. The same portions as those of the aforementioned embodiment will be designated by the same reference numerals and will not be described again.

The collector pipe 300 may transfer the solar energy supplied by the lens 200 to the solar energy collection pipe 100. To this end, the collector pipe 300 may be made of a material having high heat conductivity. For example, the collector pipe 300 may be made of aluminum, copper or an alloy thereof, which is high in heat conductivity.

The solar energy collection pipe 100 may be disposed inside the collector pipe 300. A void V may be formed between the inner surface of the collector pipe 300 and the outer surface of the solar energy collection pipe 100. The void V may be subjected to an insulating treatment (e.g., a vacuum treatment) or may not be subjected to an insulating treatment. The void V is capable of effectively transferring the solar energy passing through the collector pipe 300 to the solar energy collection pipe 100 with no loss of heat.

The collector pipe 300 may include a tubular collector body portion 310 spaced apart by a predetermined distance from the outer surface of the solar energy collection pipe 100, and a collector window portion 330 formed in a focusing portion F of the collector pipe 300 on which solar energy is concentrated. The focusing portion may refer to the portion of the collector pipe 300 through which the solar energy focused by the lens 200 passes. The separation distance between the collector body portion 310 and the outer surface of the solar energy collection pipe 100 may be kept constant along the circumference of the outer surface of the solar energy collection pipe 100 and may be kept constant along the longitudinal direction of the solar energy collection pipe 100.

The collector window portion 330 may be a one-way window (e.g., a polarizing glass) that permits transfer of radiant solar energy only in one direction in which solar energy is incident.

In the present embodiment, the collector pipe 300 may have a tubular shape with a circular ring-shaped cross section. Needless to say, the present invention is not limited thereto. The collector pipe 300 may be in the form of a tube having various cross sections. For example, the collector pipe 300 may have an elliptical ring-shaped cross section or a polygonal ring-shaped cross section.

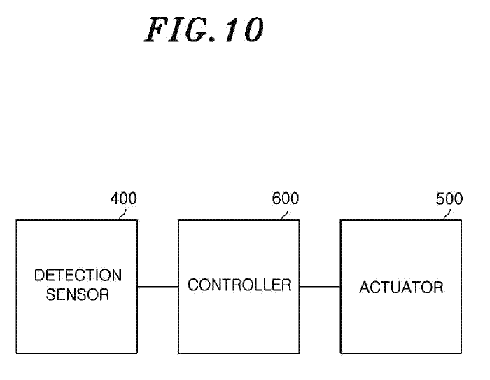

FIG. 10 is a sectional view showing a solar energy collector for a solar energy power generation system according to a seventh modification of one embodiment of the present invention.

As shown in FIG. 10, the solar energy collector according to the seventh modification of the present invention may further include a detection sensor 400, an actuator 500 and a controller 600. Hereinafter, the seventh modification will be described with an emphasis placed on the difference between the aforementioned embodiment and the seventh modification. The same portions as those of the aforementioned embodiment will be designated by the same reference numerals and will not be described again.

The detection sensor 400 may measure the incident angle of solar energy in real time. For example, the detection sensor 400 may measure the incident angle of solar energy at predetermined time intervals and may apply the measured incident angle information to the controller 600.

The actuator 500 may rotate the solar energy collection pipe 100, the collector pipe 300 and the lens 200 by a predetermined angle. The actuator 500 may be installed in an actuation frame (not shown) and may provide a rotational force to the actuation frame.

Therefore, when an actuation signal is applied from the controller 600 to the actuator 500, the actuation frame holding the solar energy collection pipe 100, the collector pipe 300 and the lens 200 may be rotated by the actuator 500. By the rotation of the actuation frame, the solar energy collection window portion 130, the collector window portion 330 and the lens 200 may be kept parallel to the solar energy irradiation direction.

Upon receiving the angle information on the incidence angle of solar energy from the detection sensor 400, the controller 600 may rotate the solar energy collection window portion 130, the collector window portion 330 and the lens 200 in conformity with the angle information on the incidence angle applied from the detection sensor 400. For example, the controller 600 may rotate the solar energy collection pipe 100 and the collector pipe 300 so that the solar energy collection window portion 130 and the collector window portion 330 can face the incidence direction of solar energy, and may rotate the lens 200 so that the solar energy can be on average incident in a direction substantially perpendicular to the longitudinal direction and the transverse direction of the lens 200. The controller 600 may be realized by an operation device including a microprocessor. The method of realizing the controller 600 is apparent to those having an ordinary knowledge in the art and, therefore, will not be described in detail.

For example, when the detection sensor 400 applies the angle information on the incidence angle of solar energy to the controller 600, the controller 600 may apply an actuation signal for rotating the solar energy collection pipe 100, the collector pipe 300 and the lens 200 based on the angle information of the detection sensor 400 to the actuator 500. The actuator 500 controlled by the controller 600 may rotate the solar energy collection window portion 130, the collector window portion 330 and the lens 200 to be arranged parallel to the irradiation direction of solar energy. This makes it possible to enhance the collection efficiency of solar energy.

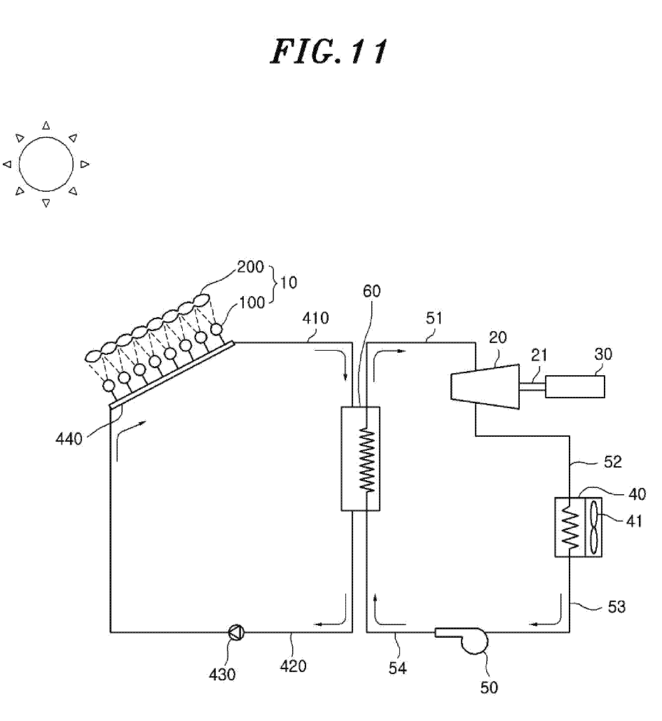

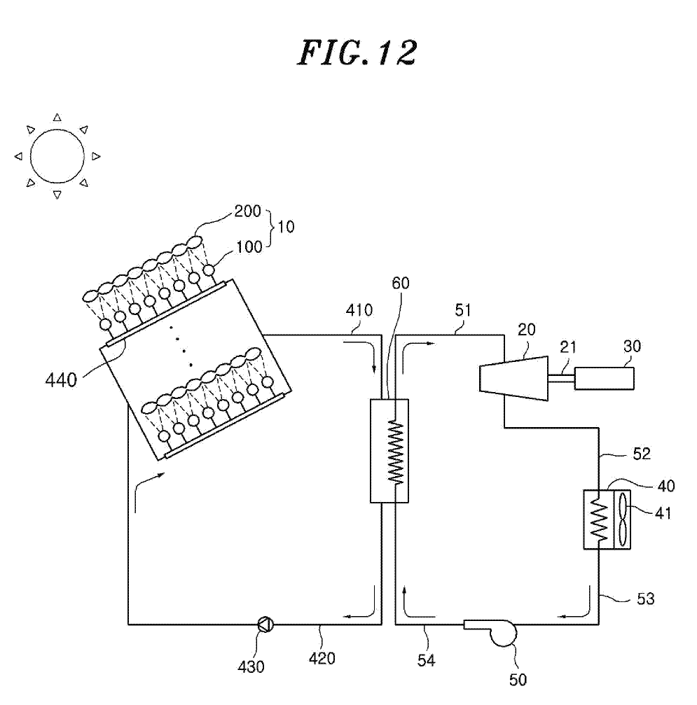

FIG. 11 is a conceptual diagram showing a solar energy power generation system according to another embodiment of the present invention. FIG. 12 is a conceptual diagram showing a state in which a plurality of lenses and a plurality of solar energy collection pipes are collectively arranged in the solar energy power generation system according to another embodiment of the present invention.

As shown in FIG. 11, the solar energy power generation system according to another embodiment of the present invention may include a solar energy collector 10 configured to collect solar energy through a solar energy collection pipe 100 to heat an energy absorption medium existing inside the solar energy collection pipe 100, a heat exchanger 60 configured to heat a working fluid using the heated energy absorption medium, a steam turbine 20 configured to generate kinetic energy using the working fluid in a gaseous state, a generator 30 configured to convert the kinetic energy of the steam turbine 20 into electric energy, a condenser 40 configured to cool the working fluid in the gaseous state into a liquid state, and a circulation pump 50 configured to circulate the working fluid.

The energy absorption medium of the solar energy collector 10 may absorb the heat of solar energy. In this regard, the energy absorption medium may include all kinds of fluids capable of absorbing solar energy (solar radiant heat) and capable of being fed. As an example, the energy absorption medium may be a volatile fluid (methanol, acetone, mercury, etc.), water (including water vapor), oil, an ethylene glycol mixture, and the like. The energy absorption medium may be moved to the heat exchanger 60 and may heat the working fluid through the heat exchange with the working fluid existing in the heat exchanger 60.

The solar energy collector 10 may effectively absorb solar energy through a plurality of solar energy collection pipes 100 arranged in a row, column or matrix pattern. For example, the solar energy collection pipes 100 may be arranged side by side in at least one of the horizontal direction and the vertical direction. In this case, the solar energy collection pipes 100 may be connected in parallel. The respective solar energy collection pipes 100 may be connected to one main pipe 440.

The solar energy collector 10 may include a solar energy collection pipe 100 provided in the form of a hollow tube, a lens 200 configured to concentrate solar energy on the solar energy collection pipe 100, a first collection line 410 configured to guide the energy absorption medium discharged from the solar energy collection pipe 100 toward the heat exchanger 60, a second collection line 420 configured to guide the energy absorption medium discharged from the heat exchanger 60 toward the solar energy collection pipe 100, and a collection pump 430 configured to circulate the energy absorption medium between the solar energy collection pipe 100 and the heat exchanger 60. The present embodiment will be described with an emphasis placed on the difference between the aforementioned one embodiment and the present embodiment. The same portions as those of the aforementioned one embodiment will be designated by the same reference numerals and will not be described again.

The heat exchanger 60 may be an evaporator configured to allow the energy absorption medium and the working fluid to exchange heat with each other. The heat exchanger 60 may change the phase of at least a part of the working fluid into a gaseous state. In this regard, the working fluid may include all kinds of fluids capable of absorbing thermal energy of the energy absorption medium and undergoing a phase change (from a gas to a liquid or vice versa). For example, the working fluid may be ammonia, Freon or propane. In addition, the working fluid may be propylene, chloroform or hexafluoropropylene.

The steam turbine 20 may be a turbine device applied to a Rankine cycle. The steam turbine 20 may receive a working fluid in a gaseous (steam) state from the heat exchanger 60 and may generate kinetic energy.

The steam turbine 20 may be operated by the expansion pressure of the working fluid and the contraction force due to condensing. Since the rotating shaft (not shown) of the steam turbine 20 and the driving shaft 21 of the generator are integrally formed or directly connected, the generator 30 may be operated by the steam turbine 20. When the driving shaft 21 of the generator 30 is rotated by the steam turbine 20, electric energy is generated in the generator 30. In the present embodiment, the generator 30 may be a high-speed generator.

The steam turbine 20 may receive the working fluid of the heat exchanger 60 through a first power generation line and may supply the received working fluid to the condenser 40 through a second power generation line 52.

The generator 30 may be a generator used in a Rankine cycle for the generation of electric energy and may generate electric energy through the rotation of the driving shaft by the operation of the steam turbine 20.

For example, the generator 30 may include a rotor connected to the driving shaft, a stator installed so as to surround the rotor, and a generator case on which the stator is installed. The configurations of the rotor and the stator are identical with or similar to the configurations of the rotor and the stator used for a typical generator and, therefore, will not be described in detail.

The condenser 40 may receive the working fluid in a gaseous state discharged from the steam turbine 20 and may cool at least a part of the working fluid in a gaseous state into a liquid state. For example, the condenser 40 may condense the working fluid into a liquid state through the heat exchange between the external heat source (air) and the working fluid.

The condenser 40 may include a blower fan 41. The blower fan 41 may promote the heat exchange between the working fluid and the external heat source (air). In particular, the flow of the air as the external heat source may be controlled by the blower fan 41. Accordingly, the total energy amount of the solar energy power generation system may be controlled through the control of the blower fan 41.

The condenser 40 may be connected to the steam turbine 20 through the second power generation line 52 and may be connected to the circulation pump 50 through the third power generation line 53. The condenser 40 may receive the working fluid in a gaseous state from the steam turbine 20 through the second power generation line 52 and may supply the working fluid in a liquid state to the circulation pump 50 through the third power generation line 53.

The circulation pump 50 may increase the pressure of the working fluid supplied from the condenser 40 in order to circulate the working fluid on the cycle of the solar energy power generation system. By adjusting the pressure level of the working fluid, the circulation pump 50 may control the total energy amount of the solar energy power generation system.

The circulation pump 50 may be connected to the condenser 40 through the third power generation line 53 and may be connected to the heat exchanger 60 through the fourth power generation line 54. In the present embodiment, the circulation pump 50 is positioned between the third power generation line 53 and the fourth power generation line 54. However, the position thereof is not limited thereto. The position of the circulation pump 50 may be variously changed in order to smoothly circulate the working fluid on the cycle of the solar energy power generation system.

As shown in FIG. 12, in the solar energy power generation system according to the present embodiment, a plurality of solar energy collectors 10 including solar energy collection pipes 100 and lenses 200 for the collection of solar energy may be collectively arranged in a mutually connected state.

For example, the solar energy collectors 10 including the solar energy collection pipes 100 and the lenses 200 connected in row may be collectively disposed in parallel. That is to say, the solar energy collectors 10 may include plural pairs of solar energy collection pipes 100 and lenses 200.

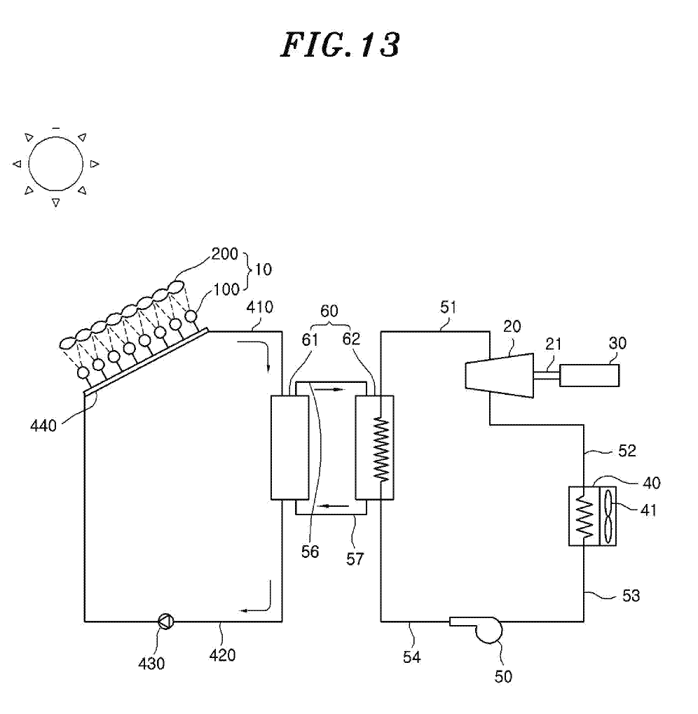

FIG. 13 is a conceptual diagram showing a solar energy power generation system according to a further embodiment of the present invention.

As shown in FIG. 13, in the solar energy power generation system according to a further embodiment of the present invention, the heat exchanger 60 may include a storage tank part 61 configured to heat a medium fluid using the thermal energy of the energy absorption medium, and a heat exchange part 62 configured to heat the working fluid through the heat exchange between the medium fluid of the storage tank part 61 and the working fluid circulating through the steam turbine 20.

In this case, the storage tank part 61 and the heat exchange part 62 may be connected to each other through a first circulation line 56 and a second circulation line 57 for circulating the medium fluid. The medium fluid may include all kinds of fluids that can absorb the thermal energy of the energy absorption medium and can permit heat exchange with the working fluid.

### Example 1

A performance test according to Example 1 of the present invention was conducted in order to evaluate the solar energy collection efficiency. The performance test satisfies the following test conditions.
a. Average solar heat intensity: 750 W/m²
b. Ambient temperature: 23° C.
c. Tap water (medium) temperature: 22° C.
d. Tap water (medium) amount: 785 cc
e. Size of Fresnel lens used: 49 cm×49 cm=2,401 cm²=0.2401 m²

As a result of the performance test conducted under the above conditions, it was confirmed that 31 minutes are required for increasing the temperature of the tap water in the solar energy collector to 100° C. It has been also confirmed that the amount of heat collected for 31 minutes by the solar energy power generation system according to Example 1 is 252,902 Joule. This is equal to the output of 136.0 W which is the average power of the solar energy power generation system.

Since the power of the solar heat passing through the lens having the size of 0.2401 m² of Example 1 is 750 W/m×0.2401 m²=180.1 W, the efficiency of the solar energy collector is represented by (136.0 W)/1(80.1 W)×100=75.5%.

### Example 2

A performance test according to Example 2 of the present invention was conducted in order to evaluate the maximum reaching temperature. The performance test satisfies the following test conditions.
a. Average solar heat intensity: 750 W/m²
b. Ambient temperature: 23° C.
c. Size of Fresnel lens used: 49 cm×49 cm=2,401 cm²
d. Size of solar energy collector: 5 cm in diameter and 49 cm in length
e. Material in solar energy collector: natural air

When about 9 minutes was elapsed after operating the solar energy power generation system of Example 2 under the above conditions, the temperature of the natural air was raised to 383° C. This means that the maximum reaching temperature of the system according to Example 2 is 383° C. when the ambient temperature is 23° C.

As described above, the solar energy power generation system of the present invention is capable of receiving the heat required for solar energy power generation through the effective collection of solar energy in solar energy collection pipe. This makes it possible to stably generate electricity.

Although exemplary embodiments of the present invention are described above with reference to the accompanying drawings, those skilled in the art will understand that the present invention may be implemented in various ways without changing the necessary features or the spirit of the present invention. For example, those skilled in the art may change material, size, or the like of the each component depending on an application field, or may combine or substitute the embodiments in a form that is not explicitly disclosed in the embodiments of the present invention, which is not departed from the scope of the present invention. Therefore, it should be understood that the exemplary embodiments described above are not limiting, but only exemplary in all respects, and various modifications should be included the scope and spirit disclosed in claims of the present invention.

Explanation of symbols

| | |
|---|---|
| 10: solar energy collector | 20: steam turbine |
| 30: generator | 40: condenser |
| 50: circulation pump | 60: heat exchanger |
| 100: solar energy collection pipe | |
| 110: solar energy collection body portion | |
| 120: insulating portion | |
| 130: solar energy collection window portion | |
| 140: solar energy reflector portion | |
| 200: lens | 300: collector pipe |
| 310: collector body portion | |
| 330: collector window portion | |
| 400: detection sensor | 500: actuator |
| 600: controller | |

1. A solar energy power generation system, comprising:
a solar energy collector configured to collect solar energy and to convert an energy absorption medium into a gaseous state;
a steam turbine configured to generate kinetic energy using the energy absorption medium in the gaseous state generated in the solar energy collector;
a generator configured to convert the kinetic energy generated in the steam turbine into electric energy;
a condenser configured to cool the energy absorption medium in the gaseous state discharged from the steam turbine into a liquid state; and
a circulation pump configured to pump the energy absorption medium in the liquid state cooled by the condenser toward the solar energy collector,
wherein the solar energy collector includes a solar energy collection pipe having an absorption medium flow path for allowing the energy absorption medium to flow therethrough, and at least one lens configured to concentrate solar energy on the solar energy collection pipe.

2. A solar energy power generation system, comprising:
a solar energy collector configured to collect solar heat and to heat an energy absorption medium;
a heat exchanger configured to convert a working fluid into a gaseous state using the energy absorption medium heated by the solar energy collector;
a steam turbine configured to generate kinetic energy using the working fluid in the gaseous state generated in the heat exchanger;
a generator configured to convert the kinetic energy generated in the steam turbine into electric energy;
a condenser configured to cool the working fluid in the gaseous state discharged from the steam turbine into a liquid state; and
a circulation pump configured to pump the working fluid in the liquid state cooled by the condenser toward the heat exchanger,
wherein the solar energy collector includes a solar energy collection pipe having an absorption medium flow path for allowing the energy absorption medium to flow therethrough, and at least one lens configured to concentrate solar energy on the solar energy collection pipe.

3. The system of claim 1, wherein the solar energy collection pipe includes a plurality of solar energy collection pipes arranged in a form of a row, a column or a matrix.

4. The system of claim 1, wherein the solar energy collection pipe includes:
a solar energy collection body portion including a focusing portion through which the solar energy concentrated by the lens is transmitted into the solar energy collection pipe; and
an insulating portion configured to cover at least a part of a remaining portion, of the solar energy collection body portion, other than the focusing portion.

5. The system of claim 1, wherein the solar energy collection pipe includes:
a solar energy collection support portion configured to provide the absorption medium flow path;
an insulating portion configured to cover the solar energy collection support portion; and
a solar energy collection window portion connected to the solar energy collection support portion so that the solar energy passes through the solar energy collection window portion,
wherein the solar energy collection window portion has an arc-shaped cross section whose radius of curvature is the same as a radius of curvature of the solar energy collection support portion.

6. The system of claim 5, wherein the solar energy collection pipe further includes a solar energy reflector portion disposed on an inner surface of the solar energy collection support portion, and the solar energy reflector portion has an arc-shaped cross section and is concentrically disposed with respect to the solar energy collection support portion.

7. The system of claim 1, wherein the solar energy collector further includes:
a collector pipe spaced apart by a predetermined distance from the solar energy collection pipe and configured to cover the solar energy collection pipe,
wherein the collector pipe includes a collector body portion and a collector window portion including a focusing portion configured to transmit the solar energy concentrated by the lens into the collector pipe.

8. The system of claim 2, wherein the solar energy collector further includes:
a first collection line which connects the solar energy collection pipe to the heat exchanger and allows the energy absorption medium to flow therethrough;
a second collection line which connects the heat exchanger to the solar energy collection pipe and allows the energy absorption medium to flow therethrough; and
a collection pump configured to circulate the energy absorption medium between the solar energy collection pipe and the heat exchanger.

9. The system of claim 1, wherein the lens includes a Fresnel lens disposed so that a focal line passes through an edge of the lens.

10. The system of claim 1, wherein the lens includes a Fresnel lens disposed so that a focal line passes through between a center and an edge of the lens.

11. The system of claim 1, wherein the lens includes two or more lenses.

12. The system of claim 1, 2, 10 or 11, wherein the solar energy collector includes a plurality of pairs of the lens and the solar energy collection pipe.
